(19) United States
(12) Patent Application Publication
(10) Pub. No.: US 2026/0067913 A1
(43) Pub. Date: Mar. 5, 2026

(54) ARTIFICIAL INTELLIGENCE (AI)-BASED METHOD FOR PROVIDING SERVICE

(71) Applicant: BEIJING XIAOMI MOBILE SOFTWARE CO., LTD., Beijing (CN)

(72) Inventors: Dong CHEN, Beijing (CN); Yuze SUN, Beijing (CN)

(73) Assignee: BEIJING XIAOMI MOBILE SOFTWARE CO., LTD., Beijing (CN)

(21) Appl. No.: 18/994,207

(22) PCT Filed: Jul. 25, 2022
(86) PCT No.: PCT/CN2022/107715

§ 371 Date: Jan. 14, 2025

(51) Int. Cl. H04W 72/51; H04L 41/16

(52) U.S. Cl. CPC H04W 72/51; H04L 41/16

(57) ABSTRACT

A method for providing a service based on artificial intelligence (AI) is executed by a first AI network function (NF) network element used for decision-making, including: receiving a first request message sent by an access and mobility management function (AMF) network element, the first request message indicating there is an AI service requested by a terminal device; determining, on the basis of the first request message, an execution task for implementing the AI service, and partitioning the execution task into a plurality of sub-tasks; and respectively issuing the plurality of sub-tasks to a plurality of second AI network function network elements for executing tasks, and receiving sub-task execution results sent by the second AI network function network elements.

### CROSS-REFERENCE TO RELATED APPLICATION

This application is the U.S. National Stage Application of International Application No. PCT/CN2022/107715, filed on Jul. 25, 2022, the entire disclosure of which is incorporated herein by reference.

### TECHNICAL FIELD

The present disclosure relates to a field of communication technology, and specifically to a method and an apparatus for providing a service based on artificial intelligence (AI), a device, and a storage medium.

### BACKGROUND

Since artificial intelligence (AI) technology may help network realize a higher level of autonomy, reduce costs and increase benefits, the AI technology is often used in the network to provide AI services.

In the related art, AI services are mainly provided based on the AI technology via optimization and transformation on a traditional network architecture.

However, methods in the related art are to provide AI services via the optimization and transformation on the traditional network architecture, which lacks a unified technical framework for providing AI services, and leads to fragmentation of network AI application scenarios. Furthermore, a process of providing AI services is just a simple superposition on existing network processes, and there is a lack of a universal AI service providing process, which may not meet needs of personalized AI services. Moreover, methods for providing AI services in the related art do not have sufficient fined granularity for division of AI functions, and may not deal with a plurality of tasks simultaneously.

### SUMMARY

According to a first aspect of the present disclosure, a method for providing a service based on AI is provided. The method is executed by a first AI network function (NF) network element used for decision-making, including:
receiving a first request message sent by an access and mobility management function (AMF) network element, in which the first request message indicates that there is an AI service requested by a terminal;
determining an execution task configured to realize the AI service based on the first request message, and dividing the execution task into a plurality of subtasks; and
delivering the plurality of subtasks to a plurality of second AI NF network elements for executing a task respectively, and receiving execution results of the plurality of subtasks sent by the plurality of second AI NF network elements.

According to a second aspect of the present disclosure, a method for providing a service based on AI is provided, executed by a mobility management function (AMF) network element, including:
receiving a second request message sent by a terminal, in which the second request message indicates that there is an AI service requested by the terminal;
sending a first request message to a first AI NF network element, in which the first request message indicates that there is the AI service requested by the terminal;
receiving a final service execution result corresponding to the AI service sent by the first AI NF network element; and
sending the final service execution result corresponding to the AI service to the terminal.

According to a third aspect of the present disclosure, a method for providing a service based on AI is provided, executed by a terminal, including:
sending a second request message to an AMF network element, in which the second request message indicates that there is an AI service requested by the terminal; and
receiving a final service execution result corresponding to the AI service sent by the AMF network element.

### BRIEF DESCRIPTION OF THE DRAWINGS

The above and/or other aspects and advantages of embodiments of the present disclosure will become apparent and more readily appreciated from the following descriptions made with reference to the accompanying drawings.

FIG. 1a is a schematic diagram of an architecture of a communication system according to embodiments of the present disclosure.

FIG. 1b is a schematic diagram of an architecture of a core network according to embodiments of the present disclosure.

FIG. 2 is a flowchart of a method for providing a service based on artificial intelligence (AI) according to another embodiment of the present disclosure.

FIG. 3 is a flowchart of a method for providing a service based on AI according to another embodiment of the present disclosure.

FIG. 4 is a flowchart of a method for providing a service based on AI according to another embodiment of the present disclosure.

FIG. 5 is a flowchart of a method for providing a service based on AI according to another embodiment of the present disclosure.

FIG. 6 is a flowchart of a method for providing a service based on AI according to another embodiment of the present disclosure.

FIG. 7 is a flowchart of a method for providing a service based on AI according to another embodiment of the present disclosure.

FIG. 8 is a flowchart of a method for providing a service based on AI according to another embodiment of the present disclosure.

FIG. 9 is a flowchart of a method for providing a service based on AI according to another embodiment of the present disclosure.

FIG. 10 is a flowchart of a method for providing a service based on AI according to another embodiment of the present disclosure.

FIG. 11 is a flowchart of a method for providing a service based on AI according to another embodiment of the present disclosure.

FIG. 12 is a flowchart of a method for providing a service based on AI according to another embodiment of the present disclosure.

FIG. 13 is a flowchart of a method for providing a service based on AI according to another embodiment of the present disclosure.

FIG. 14 is a flowchart of a method for providing a service based on AI according to another embodiment of the present disclosure.

FIG. 15 is a flowchart of a method for providing a service based on AI according to another embodiment of the present disclosure.

FIG. 16 is a block diagram of a communication apparatus according to an embodiment of the present disclosure.

FIG. 17 is a block diagram of a communication apparatus according to another embodiment of the present disclosure.

FIG. 18 is a block diagram of a communication apparatus according to another embodiment of the present disclosure.

FIG. 19a is a block diagram of a communication apparatus according to another embodiment of the present disclosure.

FIG. 19b is a block diagram of a communication system according to an embodiment of the present disclosure.

FIG. 20 is a block diagram of a communication device according to an embodiment of the present disclosure.

FIG. 21 is a block diagram of a chip according to an embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to embodiments of the present disclosure as recited in the appended claims.

The terms used in the embodiments of the present disclosure are solely for the purpose of describing a particular embodiment and are not intended to limit the embodiments of the present disclosure. The terms “a/an” and “the” in the singular form used in the embodiments and claims of the present disclosure are also intended to include the plural form, unless the context clearly indicates other meaning. It may also be understood that the term “and/or” as used herein refers to any or all possible combinations of one or more associated listed items.

It may be understood that although the terms first, second, third, etc. may be used to describe various information in the embodiments of the present disclosure, such information should not be limited to these terms. These terms are used only to distinguish information in the same type from one another. For example, without departing from the scope of embodiments of the present disclosure, the first information may also be referred to as the second information, and similarly, the second information may be referred to as the first information. Depending on the context, words “if” and “in case that” used here may be interpreted as “when”, “while”, or “in response to determining . . . ”.

The embodiments of the present disclosure are described in detail below. Examples of the embodiments are shown in the accompanying drawings, in which the same or similar labels throughout the present embodiment represent the same or similar elements or elements having the same or similar functions. The embodiments below with reference to the accompanying drawings are exemplary and are intended to explain the present disclosure, but should not be construed as a limitation to the present disclosure.

For convenience of understanding, terms in the present disclosure will be first introduced.

### 1. Artificial Intelligence (AI)

AI is a new technical science that researches and develops theories, methods, technologies and application systems for simulating, extending and expanding human intelligence.

### 2. Access and Mobility Management Function (AMF) Network Element

The AMF network element performs registration, connectivity, reachability, and mobility management. It provides a session management message transmission channel for a terminal and a session management function (SMF) network element, and provides authentication and authorization functions for the terminal when assessing to the network. Furthermore, it is an access point between a terminal and a control plane of a wireless core network.

### 3. Application Function (AF) Network Element

The AF network element is a network element that provides an application and authorizes a server deployed as an AF.

For convenience of understanding the method for providing a service based on AI in the embodiments of the present disclosure, a communication system to which the embodiments of the present disclosure applies is first described below:

Please refer to FIG. 1a, which is a schematic diagram of an architecture of a communication system according to embodiments of the present disclosure. The communication system may include but is not limited to one core network device and one terminal. The number and form of devices shown in FIG. 1a are as an example and do not constitute a limitation on the embodiments of the present disclosure, and may include two or more core network devices and two or more terminals in practical applications. The communication system shown in FIG. 1a includes one core network device 11 and one terminal 12 as an example.

It needs to be noted that the technical solution of the embodiments of the present disclosure may be applied to various communication systems, such as, a long term evolution (LTE) system, a 5th generation (5G) mobile communication system, a 5G new radio (NR) system, or other new mobile communication systems in the future.

The core network device 11 in the embodiments of the present disclosure is a device deployed in the core network. The function of the core network device 11 is mainly to provide user connection and management of users, complete service bearing, and provide an interface to an external network as a bearer network. For example, core network devices in a 5G NR system may include an AMF network element, a user plane function (UPF) network element, and an SMF network element.

For example, the core network device 11 in the embodiments of the present disclosure may include a location management function (LMF) network element. Optionally, the LMF network element includes a location server, which may be implemented as any one of: an LMF, an enhanced serving mobile location centre (E-SMLC), a secure user plane location (SUPL), and an SUPL location platform (SUPL SLP).

The terminal 12 in the embodiments of the present disclosure is an entity on a user side used for receiving or transmitting a signal, such as a mobile phone. The terminal may also be called a terminal device, a user equipment (UE), a mobile station (MS), a mobile terminal (MT), etc. The terminal may be a car with a communication function, a smart car, a mobile phone, a wearable device, a Pad, a computer with a wireless sending and receiving function, a virtual reality (VR) terminal, an augmented reality (AR) terminal, a wireless terminal in an industrial control, a wireless terminal in self-driving, a wireless terminal in a remote medical surgery, a wireless terminal in a smart grid, a wireless terminal in a transportation safety, a wireless terminal in a smart city, a wireless terminal in a smart home and so on. The specific technology and device form adopted by the terminal are not limited in the embodiments of the present disclosure.

The core network device 11 and the terminal 12 may communicate via a base station.

Please refer to FIG. 1b, which is a schematic diagram of an architecture of a core network according to embodiments of the present disclosure. FIG. 1b includes network elements included in a core network architecture and interfaces used for communication between network elements.

The core network architecture is to abstract the functions of the network elements into a plurality of services. Compared with the traditional core network architecture, N network elements including AI0, AI1, AI2 . . . . AIN are added to the core network architecture in FIG. 1b. The AI0 is a decision-making network element used to allocate AI tasks to the AI1, AI2 . . . . AIN, and the AI1, AI2 . . . . AIN are network elements that provide AI functions. The AI0 may be a first AI NF network element for decision-making mentioned in the following embodiments, the AI1, AI2 . . . . AIN may be second AI NF network elements for executing tasks mentioned in the following embodiments. The AI0, AI1, AI2 . . . . AIN may communicate with another network element in a network, such as an AMF network element and an SMF network element.

It may be understood that the communication system in the embodiments of the present disclosure is intended to illustrate the technical solution in the embodiments of the present disclosure more clearly, and does not constitute a limitation of the technical solution in the embodiments of the present disclosure. Those skilled in the art may know that the technical solution in the embodiments of the present disclosure is equally applicable to similar technical problems, with the evolution of a system architecture and the emergence of a new service scene.

In addition, it needs to be noted that the method of the present disclosure is specifically implemented on the basis of the following operations that has been completed.
(1) the terminal has completed an initial registration process and has been connected to a network.
(2) AI NF network elements (i.e., AI0, AI1, and AI2 . . . . AIN in FIG. 1b) have been registered at a network repository function (NRF) and may be accessed to the core network architecture normally.
(3) the core network has authorized each AI NF to ensure the secure access of the AI NF.
(4) the AI0 and AI1/ . . . /AIN trust each other and transmit real communication information.
(5) Every time the AI0 allocates a task, each AI NF (i.e., AI1/ . . . /AIN) is responsible for a part of a whole task, and executes their respective parts in parallel to complete the whole task.
(6) there is a certain correlation among tasks received by AI1/ . . . /AIN, which belong to a same category. For example, AI1/ . . . /AIN receive an image segmentation task, an entity annotation task, an object detection task, and a face recognition task respectively. The image segmentation task, the entity annotation task, the object detection task, and the face recognition task belong to the category of “analysis of a monitor video stream”.

The method and an apparatus for providing a service based on AI, a device, and a storage medium in the embodiments of the present disclosure are described in detail with reference to the accompanying drawings below.

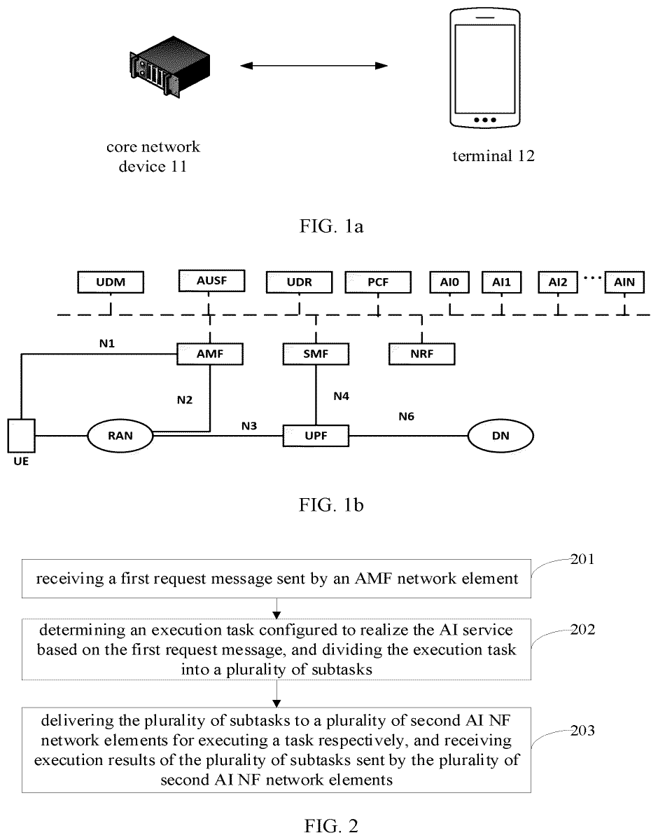

FIG. 2 is a flowchart of a method for providing a service based on AI according to the embodiments of the present disclosure. The method is executed by a first AI NF network element used for decision-making. As shown in FIG. 2, the method for providing a service based on AI may include the following steps 201-203.

At step 201, a first request message sent by an AMF network element is received.

In one embodiment of the present disclosure, the first request message indicates that there is an AI service requested by a terminal.

In one embodiment of the present disclosure, the first request message may include at least one of:

an AI service type corresponding to the AI service requested by the terminal, in which the AI service type may be a computer vision (CV), natural language processing (NLP), etc.:

an AI service identifier (ID) corresponding to the AI service requested by the terminal, in which the AI service ID is configured to uniquely indicate the AI service: or user information of the terminal.

In one embodiment of the present disclosure, the first request message may be sent to the first AI NF network element after the AMF network element receives the second request message sent (such as transparent transmission) by the terminal via the base station. The first request message may be a CreateAI0Context_Request message, and the second request message may be an AI service establishment request message.

At step 202, an execution task configured to realize the AI service is determined based on the first request message, and the execution task is divided into a plurality of subtasks.

In one embodiment of the present disclosure, after receiving the first request message, the first AI NF network element may determine the AI service specifically requested by the first request message based on the AI service ID and the AI service type, and determine the execution task to realize the AI service. Then, an AI algorithm needed to realize the AI service is analyzed, that is, the AI algorithm to be used for executing the task is analyzed, and finally the execution task is divided into a plurality of subtasks based on the AI service type and different AI algorithms used in different parts in the execution process of executing the task.

Exemplarily, assuming that the first AI NF network element determines the execution task to realize the AI service is: an analysis of a monitor video stream. The analysis of the monitor video stream may be divided into a subtask 1 of an image segmentation task, a subtask 2 of an entity annotation task, a subtask 3 of an object detection task, and a subtask 4 of a face recognition task.

It may be seen that the execution task corresponding to the AI service may be divided into a plurality of subtasks in the present disclosure, so that classified management of the AI service and the fine-grained division of AI functions may be realized, and a result of the AI service provided subsequently may be more accurate.

At step 203, the plurality of subtasks is delivered to a plurality of second AI NF network elements for executing a task respectively, and execution results of the plurality of subtasks sent by the plurality of second AI NF network elements are received.

In one embodiment of the present disclosure, different second AI NF network elements are used to execute subtasks of different task types. For example, a second AI NF network element #1 may be used to execute the image classification task, a second AI NF network element #2 may be used to execute the object detection task, and a third network element #3 may be used to execute the object recognition and positioning task.

Based on this, in one embodiment of the present disclosure, the first AI NF network element may specifically deliver the plurality of subtasks to corresponding second AI NF network elements, based on the task types corresponding to the plurality of subtasks.

Exemplarily, if the plurality of subtasks are divided into the subtask 1 of the image segmentation task, the subtask 2 of the entity annotation task, and the subtask 3 of the object detection task, the subtask 1 may be delivered to the second AI NF network element #1 for executing the image classification task, the subtask 2 may be sent to the second AI NF network element #3 for executing the object recognition and positioning task, and the subtask 3 may be sent to the second AI NF network element #2 for executing the object detection task.

When each second AI NF network element receives a subtask, the subtask may be executed to obtain the subtask execution result (such as, a subtask execution result corresponding to the subtask 1 may be a segmentation result, a subtask execution result corresponding to the subtask 2 may be an annotation sample), and the subtask execution result may be sent to the first AI NF network element. The specific execution of subtasks by the second AI NF network element will be described in detail in the subsequent embodiments corresponding to the second AI NF network element.

It needs to be noted that in one embodiment of the present disclosure, different second AI NF network elements execute their respective subtasks in parallel, thereby improving the execution efficiency.

In addition, in one embodiment of the present disclosure, after receiving execution results of each subtask, the first AI NF network element may provide the AI service for the terminal via the AMF network element based on the execution result of the subtask.

In summary, in the method for providing a service based on AI according to the embodiments of the present disclosure, the first AI NF network element used for decision-making may receive the first request message sent by the AMF network element, in which the first request message indicates that there is the AI service requested by the terminal. Then, the first AI NF network element may determine the execution task configured to realize the AI service based on the first request message, divide the execution task into the plurality of subtasks, deliver the plurality of subtasks to the plurality of second AI NF network elements for executing the task respectively, and receive execution results of the subtasks sent by the plurality of second AI NF network elements. It may be seen that the method for providing a service based on AI in the present disclosure is not a simple superposition on the existing network processes, but a complete set of general AI service providing process. Therefore, the method based on the present disclosure may accurately provide an AI service requested by a terminal to the terminal, which meets needs of personalized AI services. In addition, in the method of the present disclosure, by dividing the execution task corresponding to the AI service requested by the terminal into the plurality of subtasks, classified management of the AI service and a fine-grained division of AI functions may be realized, and a result of the AI service provided subsequently may be more accurate. Furthermore, in the method of the present disclosure, different second AI NF network elements execute subtasks in parallel, which may improve an execution efficiency. In addition, in the present disclosure, the first AI NF network element, the plurality of second AI NF network elements, and other network elements in the core network may form a unified technical framework for providing AI services, so as to avoid the problem of fragmentation of AI application scenarios.

FIG. 3 is a flowchart of a method for providing a service based on AI according to the embodiments of the present disclosure. As shown in FIG. 3, the method for providing a service based on AI may include the following steps 301-305.

At step 301, a first request message sent by an AMF network element is received.

At step 302, an execution task configured to realize the AI service is determined based on the first request message, and the execution task is divided into a plurality of subtasks.

At step 303, the plurality of subtasks is delivered to a plurality of second AI NF network elements for executing a task respectively, and execution results of the plurality of subtasks sent by the plurality of second AI NF network elements are received.

At step 304, a final service execution result corresponding to the AI service is determined based on the execution results of the plurality of subtasks.

In one embodiment of the present disclosure, the first AI NF network element may obtain the final service execution result by summarizing the execution results of the plurality of subtasks.

At step 305, the final service execution result corresponding to the AI service is sent to the AMF network element.

The final service execution result corresponding to the AI service is sent to the AMF network element, so that the AMF network element may provide the final service execution result to the terminal, which may achieve providing the AI service to the terminal.

In summary, in the method for providing a service based on AI according to the embodiments of the present disclosure, the first AI NF network element used for decision-making may receive the first request message sent by the AMF network element, in which the first request message indicates that there is the AI service requested by the terminal. Then, the first AI NF network element may determine the execution task configured to realize the AI service based on the first request message, divide the execution task into the plurality of subtasks, deliver the plurality of subtasks to the plurality of second AI NF network elements for executing the task respectively, and receive execution results of the subtasks sent by the plurality of second AI NF network elements. It may be seen that the method for providing a service based on AI in the present disclosure is not a simple superposition on the existing network processes, but a complete set of general AI service providing process. Therefore, the method based on the present disclosure may accurately provide an AI service requested by a terminal to the terminal, which meets needs of personalized AI services. In addition, in the method of the present disclosure, by dividing the execution task corresponding to the AI service requested by the terminal into the plurality of subtasks, classified management of the AI service and a fine-grained division of AI functions may be realized, and a result of the AI service provided subsequently may be more accurate. Furthermore, in the method of the present disclosure, different second AI NF network elements execute subtasks in parallel, which may improve an execution efficiency. In addition, in the present disclosure, the first AI NF network element, the plurality of second AI NF network elements, and other network elements in the core network may form a unified technical framework for providing AI services, so as to avoid the problem of fragmentation of AI application scenarios.

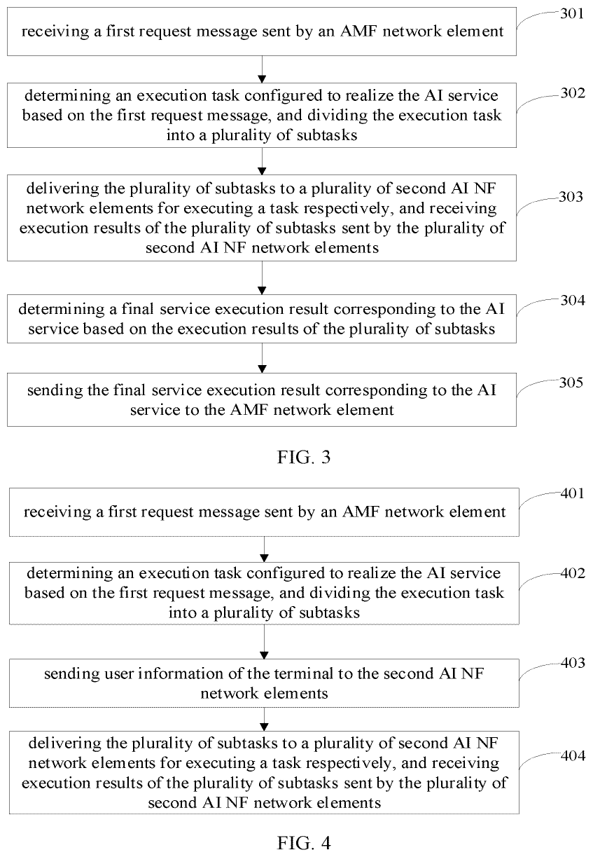

FIG. 4 is a flowchart of a method for providing a service based on AI according to the embodiments of the present disclosure. The method is executed by a first AI NF network element used for decision-making. As shown in FIG. 4, the method for providing a service based on AI may include the following steps 401-404.

At step 401, a first request message sent by an AMF network element is received.

At step 402, an execution task configured to realize the AI service is determined based on the first request message, and the execution task is divided into a plurality of subtasks.

At step 403, user information of the terminal is sent to the second AI NF network elements.

In one embodiment of the present disclosure, the first AI NF network element specifically sends the user information of the terminal included in the first request message (i.e., the user information of the terminal requesting the AI service) to the second AI NF network element. The user information of the terminal requesting the AI service is sent to the second AI NF network element, so that the second AI NF network element may execute the subtask it receives based on the user information. Specifically, when the second NF network element executes a subtask, the data needed to execute the subtask is usually obtained from the NF network element, so that the subtask may be executed based on the data. The data needed to execute the subtask should be data corresponding to the terminal requesting the AI service. Therefore, the first AI NF network element needs to send the user information of the terminal requesting the AI service to the second AI NF network element, so that the second AI NF network element may obtain the data corresponding to the terminal requesting the AI service from the NF network element and needed to execute the subtask, based on the user information of the terminal for the AI service. As a result, the second AI NF network element may successfully execute the subtask.

At step 404, the plurality of subtasks is delivered to a plurality of second AI NF network elements for executing a task respectively, and execution results of the plurality of subtasks sent by the plurality of second AI NF network elements are received.

For a detailed description of steps 401, 403 to 404, please refer to the description of the above embodiments, which is not repeated herein.

In summary, in the method for providing a service based on AI according to the embodiments of the present disclosure, the first AI NF network element used for decision-making may receive the first request message sent by the AMF network element, in which the first request message indicates that there is the AI service requested by the terminal. Then, the first AI NF network element may determine the execution task configured to realize the AI service based on the first request message, divide the execution task into the plurality of subtasks, deliver the plurality of subtasks to the plurality of second AI NF network elements for executing the task respectively, and receive execution results of the subtasks sent by the plurality of second AI NF network elements. It may be seen that the method for providing a service based on AI in the present disclosure is not a simple superposition on the existing network processes, but a complete set of general AI service providing process. Therefore, the method based on the present disclosure may accurately provide an AI service requested by a terminal to the terminal, which meets needs of personalized AI services. In addition, in the method of the present disclosure, by dividing the execution task corresponding to the AI service requested by the terminal into the plurality of subtasks, classified management of the AI service and a fine-grained division of AI functions may be realized, and a result of the AI service provided subsequently may be more accurate. Furthermore, in the method of the present disclosure, different second AI NF network elements execute subtasks in parallel, which may improve an execution efficiency. In addition, in the present disclosure, the first AI NF network element, the plurality of second AI NF network elements, and other network elements in the core network may form a unified technical framework for providing AI services, so as to avoid the problem of fragmentation of AI application scenarios.

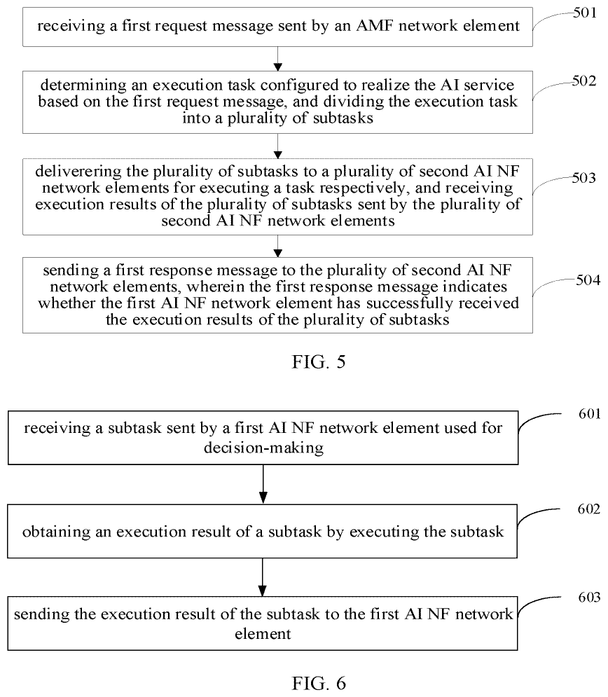

FIG. 5 is a flowchart of a method for providing a service based on AI according to the embodiments of the present disclosure. The method is executed by a first AI network function (NF) network element used for decision-making. As shown in FIG. 5, the method for providing a service based on AI may include the following steps 501-504.

At step 501, a first request message sent by an AMF network element is received.

At step 502, an execution task configured to realize the AI service is determined based on the first request message, and the execution task is divided into a plurality of subtasks.

At step 503, the plurality of subtasks is delivered to a plurality of second AI NF network elements for executing a task respectively, and execution results of the plurality of subtasks sent by the plurality of second AI NF network elements are received.

At step 504, a first response message is sent to the plurality of second AI NF network elements, in which the first response message indicates whether the first AI NF network element has successfully received the execution results of the plurality of subtasks.

In one embodiment of the present disclosure, if the first response message indicates that the first AI NF has not successfully received an execution result of a subtask, the corresponding second AI NF network element may resend the subtask execution result to the first AI NF network element. In this way, it is possible to prevent a failure of transmitting the execution result of the subtask, and to ensure that AI services are provided successfully.

In summary, in the method for providing a service based on AI according to the embodiments of the present disclosure, the first AI NF network element used for decision-making may receive the first request message sent by the AMF network element, in which the first request message indicates that there is the AI service requested by the terminal. Then, the first AI NF network element may determine the execution task configured to realize the AI service based on the first request message, divide the execution task into the plurality of subtasks, deliver the plurality of subtasks to the plurality of second AI NF network elements for executing the task respectively, and receive execution results of the subtasks sent by the plurality of second AI NF network elements. It may be seen that the method for providing a service based on AI in the present disclosure is not a simple superposition on the existing network processes, but a complete set of general AI service providing process. Therefore, the method based on the present disclosure may accurately provide an AI service requested by a terminal to the terminal, which meets needs of personalized AI services. In addition, in the method of the present disclosure, by dividing the execution task corresponding to the AI service requested by the terminal into the plurality of subtasks, classified management of the AI service and a fine-grained division of AI functions may be realized, and a result of the AI service provided subsequently may be more accurate. Furthermore, in the method of the present disclosure, different second AI NF network elements execute subtasks in parallel, which may improve an execution efficiency. In addition, in the present disclosure, the first AI NF network element, the plurality of second AI NF network elements, and other network elements in the core network may form a unified technical framework for providing AI services, so as to avoid the problem of fragmentation of AI application scenarios.

FIG. 6 is a flowchart of a method for providing a service based on AI according to the embodiments of the present disclosure. The method is executed by a second AI NF network element used for executing a task. As shown in FIG. 6, the method for providing a service based on AI may include the following steps 601-603.

At step 601, a subtask sent by a first AI NF network element used for decision-making is received.

In one embodiment of the present disclosure, the second AI NF network element may also receive the user information of the terminal requesting the AI service sent by the first AI NF network element while receiving the subtask sent by the first AI NF network element.

At step 602, an execution result of a subtask is obtained by executing the subtask.

In one embodiment of the present disclosure, the method for executing the subtask by the second AI NF network element may include the following steps 1-2.

Step 1: data needed to execute the subtask is obtained from an NF network element based on the subtask.

In one embodiment of the present disclosure, the NF network element may be a user data repository (UDR) network element; or an unstructured data storage network function (UDSF) network element. The UDR network element stores a structured data collection and the UDSF network element stores an unstructured data collection. In addition, the data stored in the UDR network element and the UDSF network element is mainly from the data provided by the terminal when registering, or data corresponding to the AI service requested by the terminal that is provided to the NF network element synchronously when the terminal is requesting the AI service.

In one embodiment of the present disclosure, the method that the second AI NF network element obtains the data needed to execute the subtask from the NF network element may mainly include at least one of the following methods 1-2.
Method 1: the second AI NF network element first determines a type of data needed by the second AI NF network element to execute the subtask based on a received subtask, and then sends a data request message to an NF network element. The data request message includes user information of the terminal requesting an AI service and the type of the data needed by the second AI NF network element to execute the subtask. At the moment, the NF network element may determine the data corresponding to the terminal requesting the AI service based on the user information of the terminal requesting the AI service, select the data needed to execute the subtask from the data corresponding to the terminal requesting the AI service based on the type of data needed by the second AI NF network element to execute the subtask, and send the selected data to the second AI NF network element.
Method 2: the second AI NF network element directly sends a data request message to an NF network element, and the data request message includes a subtask to be executed by the second AI NF network element and user information of the terminal requesting the AI service. Then, the NF network element may directly determine the data needed by the second AI NF network element to execute the subtask, based on the subtask to be executed by the second AI NF network element and the user information of the terminal requesting the AI service, and send the determined data to the second AI NF network element.

Step 2: a corresponding execution result of the subtask is obtained by executing the subtask based on data that the second AI NF network element obtains.

Specifically, in one embodiment of the present disclosure, the second AI NF network element includes at least one AI model. Different AI models are used to execute different subtasks. In addition, after obtaining the data needed to execute the subtask, the second AI NF network element may select an AI model suitable for the subtask to be executed, and use the data that the second AI NF network element obtains as an input of the selected AI model, so that the AI model outputs the execution result of the subtask.

From the above content, it may be seen that the second AI NF network element may determine the execution result of the subtask by executing the above steps 1-2. It needs be noted that in one embodiment of the present disclosure, different second AI NF network elements execute their respective subtasks in parallel, thus improving the execution efficiency.

At step 603, the execution result of the subtask is sent to the first AI NF network element.

In summary, in the method for providing a service based on AI according to the embodiments of the present disclosure, the first AI NF network element used for decision-making may receive the first request message sent by the AMF network element, in which the first request message indicates that there is the AI service requested by the terminal. Then, the first AI NF network element may determine the execution task configured to realize the AI service based on the first request message, divide the execution task into the plurality of subtasks, deliver the plurality of subtasks to the plurality of second AI NF network elements for executing the task respectively, and receive execution results of the subtasks sent by the plurality of second AI NF network elements. It may be seen that the method for providing a service based on AI in the present disclosure is not a simple superposition on the existing network processes, but a complete set of general AI service providing process. Therefore, the method based on the present disclosure may accurately provide an AI service requested by a terminal to the terminal, which meets needs of personalized AI services. In addition, in the method of the present disclosure, by dividing the execution task corresponding to the AI service requested by the terminal into the plurality of subtasks, classified management of the AI service and a fine-grained division of AI functions may be realized, and a result of the AI service provided subsequently may be more accurate. Furthermore, in the method of the present disclosure, different second AI NF network elements execute subtasks in parallel, which may improve an execution efficiency. In addition, in the present disclosure, the first AI NF network element, the plurality of second AI NF network elements, and other network elements in the core network may form a unified technical framework for providing AI services, so as to avoid the problem of fragmentation of AI application scenarios.

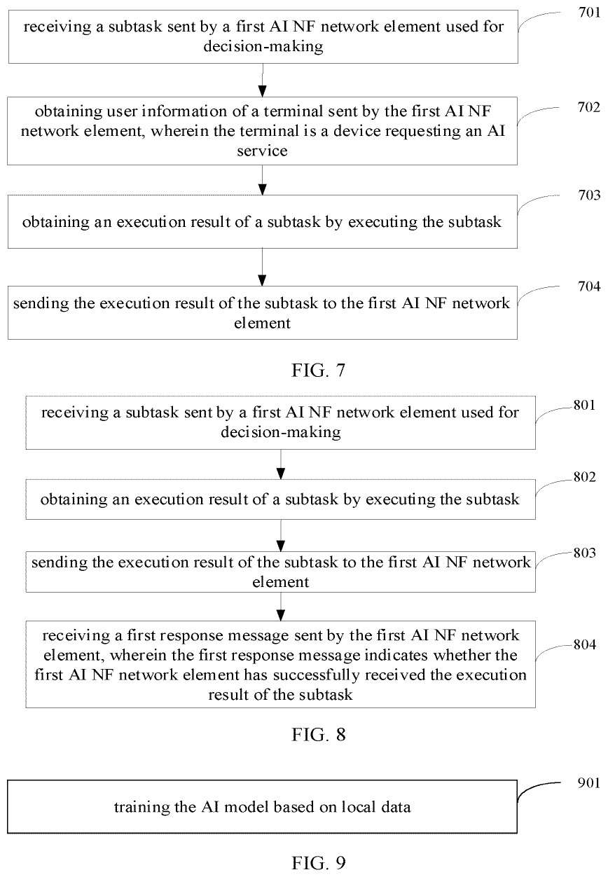

FIG. 7 is a flowchart of a method for providing a service based on AI according to the embodiments of the present disclosure. The method is executed by a second AI NF network element used for executing a task. As shown in FIG. 7, the method for providing a service based on AI may include the following steps 701-704.

At step 701, a subtask sent by a first AI NF network element used for decision-making is received.

At step 702, user information of a terminal sent by the first AI NF network element is obtained, in which the terminal is a device requesting an AI service.

At step 703, an execution result of a subtask is obtained by executing the subtask.

At step 704, the execution result of the subtask is sent to the first AI NF network element.

For a detailed description of steps 701 to 704, please refer to the description of the above embodiments, which is not repeated herein.

In summary, in the method for providing a service based on AI according to the embodiments of the present disclosure, the first AI NF network element used for decision-making may receive the first request message sent by the AMF network element, in which the first request message indicates that there is the AI service requested by the terminal. Then, the first AI NF network element may determine the execution task configured to realize the AI service based on the first request message, divide the execution task into the plurality of subtasks, deliver the plurality of subtasks to the plurality of second AI NF network elements for executing the task respectively, and receive execution results of the subtasks sent by the plurality of second AI NF network elements. It may be seen that the method for providing a service based on AI in the present disclosure is not a simple superposition on the existing network processes, but a complete set of general AI service providing process. Therefore, the method based on the present disclosure may accurately provide an AI service requested by a terminal to the terminal, which meets needs of personalized AI services. In addition, in the method of the present disclosure, by dividing the execution task corresponding to the AI service requested by the terminal into the plurality of subtasks, classified management of the AI service and a fine-grained division of AI functions may be realized, and a result of the AI service provided subsequently may be more accurate. Furthermore, in the method of the present disclosure, different second AI NF network elements execute subtasks in parallel, which may improve an execution efficiency. In addition, in the present disclosure, the first AI NF network element, the plurality of second AI NF network elements, and other network elements in the core network may form a unified technical framework for providing AI services, so as to avoid the problem of fragmentation of AI application scenarios.

FIG. 8 is a flowchart of a method for providing a service based on AI according to the embodiments of the present disclosure. The method is executed by a second AI NF network element used for executing a task. As shown in FIG. 8, the method for providing a service based on AI may include the following steps 801-804.

At step 801, a subtask sent by a first AI NF network element used for decision-making is received.

At step 802, an execution result of a subtask is obtained by executing the subtask.

At step 803, the execution result of the subtask is sent to the first AI NF network element.

For a detailed description of steps 801 to 803, please refer to the description of the above embodiments, which is not repeated herein.

At step 804, a first response message sent by the first AI NF network element is received, in which the first response message indicates whether the first AI NF network element has successfully received the execution result of the subtask.

In one embodiment of the present disclosure, in response to the first response message indicating that the first AI NF network element has successfully received the execution result of the subtask, the second AI NF network element does not need to send the execution result of the subtask to the first AI NF network element.

In one embodiment of the present disclosure, in response to the first response message indicating that the first AI NF network element has not successfully received the execution result of the subtask, the second AI NF network element needs to resend the execution result of the subtask to the first AI NF network element.

In summary, in the method for providing a service based on AI according to the embodiments of the present disclosure, the first AI NF network element used for decision-making may receive the first request message sent by the AMF network element, in which the first request message indicates that there is the AI service requested by the terminal. Then, the first AI NF network element may determine the execution task configured to realize the AI service based on the first request message, divide the execution task into the plurality of subtasks, deliver the plurality of subtasks to the plurality of second AI NF network elements for executing the task respectively, and receive execution results of the subtasks sent by the plurality of second AI NF network elements. It may be seen that the method for providing a service based on AI in the present disclosure is not a simple superposition on the existing network processes, but a complete set of general AI service providing process. Therefore, the method based on the present disclosure may accurately provide an AI service requested by a terminal to the terminal, which meets needs of personalized AI services. In addition, in the method of the present disclosure, by dividing the execution task corresponding to the AI service requested by the terminal into the plurality of subtasks, classified management of the AI service and a fine-grained division of AI functions may be realized, and a result of the AI service provided subsequently may be more accurate. Furthermore, in the method of the present disclosure, different second AI NF network elements execute subtasks in parallel, which may improve an execution efficiency. In addition, in the present disclosure, the first AI NF network element, the plurality of second AI NF network elements, and other network elements in the core network may form a unified technical framework for providing AI services, so as to avoid the problem of fragmentation of AI application scenarios.

FIG. 9 is a flowchart of a method for providing a service based on AI according to the embodiments of the present disclosure. The method is executed by a second AI NF network element used for executing a task. As shown in FIG. 9, the method for providing a service based on AI may include the following step 901.

At step 901, the AI model is trained based on local data.

In one embodiment of the present disclosure, each second AI NF network element may use local data separately for training the corresponding AI model. Each AI NF network element may select an appropriate parameter optimization method (such as a stochastic gradient descent (SGD) and an adaptive moment estimation (Adam)) to train the AI model based on its own situation.

Exemplarily, in one embodiment of the present disclosure, for example, the second AI NF network element for executing the image classification task may use a cifar-10 image dataset or use a VGGNet neural network to train the AI model: the second AI NF network element for executing the object detection task may use a Faster-RCNN (Region Convolutional Neural Network) algorithm to train the AI model; and the second AI NF network element for executing the object recognition and positioning task may use a you only look once (YOLO) algorithm to train the AI model.

Further, in one embodiment of the present disclosure, the second AI NF network element may train the AI model when the AI model is initially built, or, train the AI model that executes a subtask when the subtask is received. In the embodiments of the present disclosure, a training occasion of the AI model is not specifically limited.

In summary, in the method for providing a service based on AI according to the embodiments of the present disclosure, the first AI NF network element used for decision-making may receive the first request message sent by the AMF network element, in which the first request message indicates that there is the AI service requested by the terminal. Then, the first AI NF network element may determine the execution task configured to realize the AI service based on the first request message, divide the execution task into the plurality of subtasks, deliver the plurality of subtasks to the plurality of second AI NF network elements for executing the task respectively, and receive execution results of the subtasks sent by the plurality of second AI NF network elements. It may be seen that the method for providing a service based on AI in the present disclosure is not a simple superposition on the existing network processes, but a complete set of general AI service providing process. Therefore, the method based on the present disclosure may accurately provide an AI service requested by a terminal to the terminal, which meets needs of personalized AI services. In addition, in the method of the present disclosure, by dividing the execution task corresponding to the AI service requested by the terminal into the plurality of subtasks, classified management of the AI service and a fine-grained division of AI functions may be realized, and a result of the AI service provided subsequently may be more accurate. Furthermore, in the method of the present disclosure, different second AI NF network elements execute subtasks in parallel, which may improve an execution efficiency. In addition, in the present disclosure, the first AI NF network element, the plurality of second AI NF network elements, and other network elements in the core network may form a unified technical framework for providing AI services, so as to avoid the problem of fragmentation of AI application scenarios.

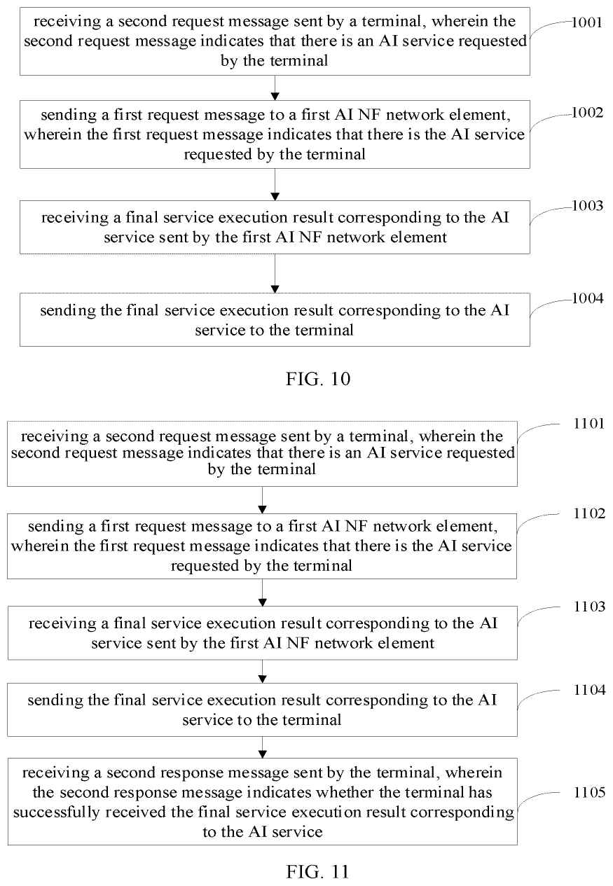

FIG. 10 is a flowchart of a method for providing a service based on AI according to the embodiments of the present disclosure. The method is executed by an AMF network element. As shown in FIG. 10, the method for providing a service based on AI may include the following steps 1001-1005.

At step 1001, a second request message sent by a terminal is received, in which the second request message indicates that there is an AI service requested by the terminal.

The second request message includes at least one of:
an AI service type corresponding to the AI service requested by the terminal;
an AI service ID corresponding to the AI service requested by the terminal; or
user information of the terminal.

Exemplarily, the second request message may be an AI service establishment request message.

At step 1002, a first request message is sent to a first AI NF network element, in which the first request message indicates that there is the AI service requested by the terminal.

At step 1003, a final service execution result corresponding to the AI service sent by the first AI NF network element is received.

At step 1004, the final service execution result corresponding to the AI service is sent to the terminal.

The AMF network element may transparently transmit the final service execution result to the terminal via the base station.

For a detailed description of steps 1001 to 1004, please refer to the description of the above embodiments.

In summary, in the method for providing a service based on AI according to the embodiments of the present disclosure, the first AI NF network element used for decision-making may receive the first request message sent by the AMF network element, in which the first request message indicates that there is the AI service requested by the terminal. Then, the first AI NF network element may determine the execution task configured to realize the AI service based on the first request message, divide the execution task into the plurality of subtasks, deliver the plurality of subtasks to the plurality of second AI NF network elements for executing the task respectively, and receive execution results of the subtasks sent by the plurality of second AI NF network elements. It may be seen that the method for providing a service based on AI in the present disclosure is not a simple superposition on the existing network processes, but a complete set of general AI service providing process. Therefore, the method based on the present disclosure may accurately provide an AI service requested by a terminal to the terminal, which meets needs of personalized AI services. In addition, in the method of the present disclosure, by dividing the execution task corresponding to the AI service requested by the terminal into the plurality of subtasks, classified management of the AI service and a fine-grained division of AI functions may be realized, and a result of the AI service provided subsequently may be more accurate. Furthermore, in the method of the present disclosure, different second AI NF network elements execute subtasks in parallel, which may improve an execution efficiency. In addition, in the present disclosure, the first AI NF network element, the plurality of second AI NF network elements, and other network elements in the core network may form a unified technical framework for providing AI services, so as to avoid the problem of fragmentation of AI application scenarios.

FIG. 11 is a flowchart of a method for providing a service based on AI according to the embodiments of the present disclosure. The method is executed by an AMF network element. As shown in FIG. 11, the method for providing a service based on AI may include the following steps 1101-1105.

At step 1101, a second request message sent by a terminal is received, in which the second request message indicates that there is an AI service requested by the terminal.

At step 1102, a first request message is sent to a first AI NF network element, in which the first request message indicates that there is the AI service requested by the terminal.

Both the first request message and the second request message include at least one of:
an AI service type corresponding to the AI service requested by the terminal;
an AI service ID corresponding to the AI service requested by the terminal; or
user information of the terminal.

At step 1103, a final service execution result corresponding to the AI service sent by the first AI NF network element is received.

At step 1104, the final service execution result corresponding to the AI service is sent to the terminal.

At step 1105, a second response message sent by the terminal is received, in which the second response message indicates whether the terminal has successfully received the final service execution result corresponding to the AI service.

In one embodiment of the present disclosure, when the second response message indicates that the terminal has not successfully received the final service execution result corresponding to the AI service, the AMF network element needs to retransmit the final service execution result corresponding to the AI service to the terminal.

In summary, in the method for providing a service based on AI according to the embodiments of the present disclosure, the first AI NF network element used for decision-making may receive the first request message sent by the AMF network element, in which the first request message indicates that there is the AI service requested by the terminal. Then, the first AI NF network element may determine the execution task configured to realize the AI service based on the first request message, divide the execution task into the plurality of subtasks, deliver the plurality of subtasks to the plurality of second AI NF network elements for executing the task respectively, and receive execution results of the subtasks sent by the plurality of second AI NF network elements. It may be seen that the method for providing a service based on AI in the present disclosure is not a simple superposition on the existing network processes, but a complete set of general AI service providing process. Therefore, the method based on the present disclosure may accurately provide an AI service requested by a terminal to the terminal, which meets needs of personalized AI services. In addition, in the method of the present disclosure, by dividing the execution task corresponding to the AI service requested by the terminal into the plurality of subtasks, classified management of the AI service and a fine-grained division of AI functions may be realized, and a result of the AI service provided subsequently may be more accurate. Furthermore, in the method of the present disclosure, different second AI NF network elements execute subtasks in parallel, which may improve an execution efficiency. In addition, in the present disclosure, the first AI NF network element, the plurality of second AI NF network elements, and other network elements in the core network may form a unified technical framework for providing AI services, so as to avoid the problem of fragmentation of AI application scenarios.

FIG. 12 is a flowchart of a method for providing a service based on AI according to the embodiments of the present disclosure. The method is executed by an AMF network element. As shown in FIG. 12, the method for providing a service based on AI may include the following steps 1201-1205.

At step 1201, a second request message sent by a terminal is received, in which the second request message indicates that there is an AI service requested by the terminal.

At step 1202, a first request message is sent to a first AI NF network element, in which the first request message indicates that there is the AI service requested by the terminal.

Both the first request message and the second request message include at least one of:
an AI service type corresponding to the AI service requested by the terminal;
an AI service ID corresponding to the AI service requested by the terminal; or
user information of the terminal.

At step 1203, a final service execution result corresponding to the AI service sent by the first AI NF network element is received.

At step 1204, the final service execution result corresponding to the AI service is sent to the terminal.

At step 1205, a feedback result sent by the terminal is received, in which the feedback result is configured to feed back a satisfaction degree with the final service execution result.

In summary, in the method for providing a service based on AI according to the embodiments of the present disclosure, the first AI NF network element used for decision-making may receive the first request message sent by the AMF network element, in which the first request message indicates that there is the AI service requested by the terminal. Then, the first AI NF network element may determine the execution task configured to realize the AI service based on the first request message, divide the execution task into the plurality of subtasks, deliver the plurality of subtasks to the plurality of second AI NF network elements for executing the task respectively, and receive execution results of the subtasks sent by the plurality of second AI NF network elements. It may be seen that the method for providing a service based on AI in the present disclosure is not a simple superposition on the existing network processes, but a complete set of general AI service providing process. Therefore, the method based on the present disclosure may accurately provide an AI service requested by a terminal to the terminal, which meets needs of personalized AI services. In addition, in the method of the present disclosure, by dividing the execution task corresponding to the AI service requested by the terminal into the plurality of subtasks, classified management of the AI service and a fine-grained division of AI functions may be realized, and a result of the AI service provided subsequently may be more accurate. Furthermore, in the method of the present disclosure, different second AI NF network elements execute subtasks in parallel, which may improve an execution efficiency. In addition, in the present disclosure, the first AI NF network element, the plurality of second AI NF network elements, and other network elements in the core network may form a unified technical framework for providing AI services, so as to avoid the problem of fragmentation of AI application scenarios.

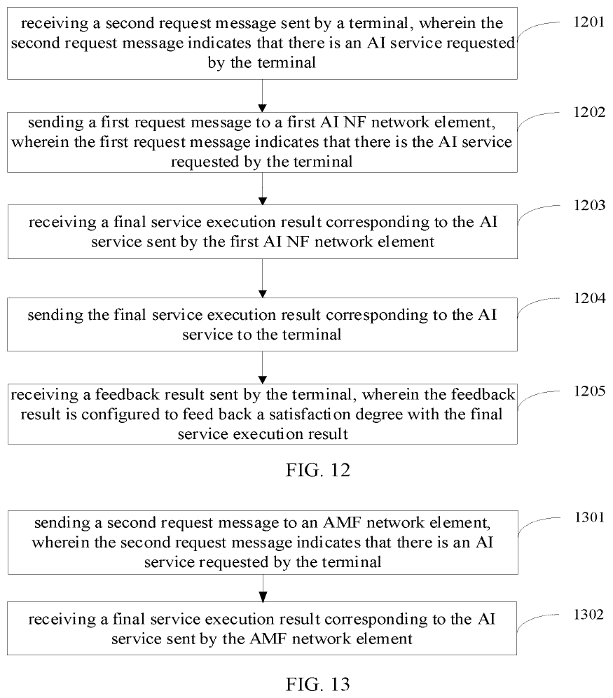

FIG. 13 is a flowchart of a method for providing a service based on AI according to the embodiments of the present disclosure. The method is executed by a terminal. As shown in FIG. 13, the method for providing a service based on AI may include the following steps 1301-1302.

At step 1301, a second request message is sent to an AMF network element, in which the second request message indicates that there is an AI service requested by the terminal.

At step 1302, a final service execution result corresponding to the AI service sent by the AMF network element is received.

In summary, in the method for providing a service based on AI according to the embodiments of the present disclosure, the first AI NF network element used for decision-making may receive the first request message sent by the AMF network element, in which the first request message indicates that there is the AI service requested by the terminal. Then, the first AI NF network element may determine the execution task configured to realize the AI service based on the first request message, divide the execution task into the plurality of subtasks, deliver the plurality of subtasks to the plurality of second AI NF network elements for executing the task respectively, and receive execution results of the subtasks sent by the plurality of second AI NF network elements. It may be seen that the method for providing a service based on AI in the present disclosure is not a simple superposition on the existing network processes, but a complete set of general AI service providing process. Therefore, the method based on the present disclosure may accurately provide an AI service requested by a terminal to the terminal, which meets needs of personalized AI services. In addition, in the method of the present disclosure, by dividing the execution task corresponding to the AI service requested by the terminal into the plurality of subtasks, classified management of the AI service and a fine-grained division of AI functions may be realized, and a result of the AI service provided subsequently may be more accurate. Furthermore, in the method of the present disclosure, different second AI NF network elements execute subtasks in parallel, which may improve an execution efficiency. In addition, in the present disclosure, the first AI NF network element, the plurality of second AI NF network elements, and other network elements in the core network may form a unified technical framework for providing AI services, so as to avoid the problem of fragmentation of AI application scenarios.

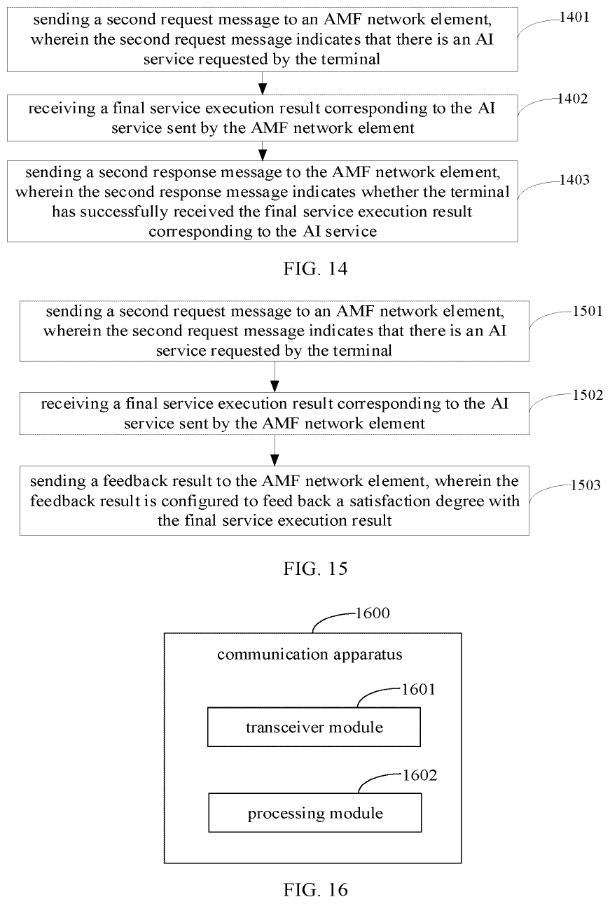

FIG. 14 is a flowchart of a method for providing a service based on AI according to the embodiments of the present disclosure. The method is executed by a terminal. As shown in FIG. 14, the method for providing a service based on AI may include the following steps 1401-1403.

At step 1401, a second request message is sent to an AMF network element, in which the second request message indicates that there is an AI service requested by the terminal.

At step 1402, a final service execution result corresponding to the AI service sent by the AMF network element is received.

At step 1403, a second response message is sent to the AMF network element, in which the second response message indicates whether the terminal has successfully received the final service execution result corresponding to the AI service.

In summary, in the method for providing a service based on AI according to the embodiments of the present disclosure, the first AI NF network element used for decision-making may receive the first request message sent by the AMF network element, in which the first request message indicates that there is the AI service requested by the terminal. Then, the first AI NF network element may determine the execution task configured to realize the AI service based on the first request message, divide the execution task into the plurality of subtasks, deliver the plurality of subtasks to the plurality of second AI NF network elements for executing the task respectively, and receive execution results of the subtasks sent by the plurality of second AI NF network elements. It may be seen that the method for providing a service based on AI in the present disclosure is not a simple superposition on the existing network processes, but a complete set of general AI service providing process. Therefore, the method based on the present disclosure may accurately provide an AI service requested by a terminal to the terminal, which meets needs of personalized AI services. In addition, in the method of the present disclosure, by dividing the execution task corresponding to the AI service requested by the terminal into the plurality of subtasks, classified management of the AI service and a fine-grained division of AI functions may be realized, and a result of the AI service provided subsequently may be more accurate. Furthermore, in the method of the present disclosure, different second AI NF network elements execute subtasks in parallel, which may improve an execution efficiency. In addition, in the present disclosure, the first AI NF network element, the plurality of second AI NF network elements, and other network elements in the core network may form a unified technical framework for providing AI services, so as to avoid the problem of fragmentation of AI application scenarios.

FIG. 15 is a flowchart of a method for providing a service based on AI according to the embodiments of the present disclosure. The method is executed by a terminal. As shown in FIG. 15, the method for providing a service based on AI may include the following steps 1501-1503.

At step 1501, a second request message is sent to an AMF network element, in which the second request message indicates that there is an AI service requested by the terminal.

At step 1502, a final service execution result corresponding to the AI service sent by the AMF network element is received.

At step 1503, a feedback result is sent to the AMF network element, in which the feedback result is configured to feed back a satisfaction degree with the final service execution result.

In one embodiment of the present disclosure, the feedback result may be determined based on a score made by a user.

In summary, in the method for providing a service based on AI according to the embodiments of the present disclosure, the first AI NF network element used for decision-making may receive the first request message sent by the AMF network element, in which the first request message indicates that there is the AI service requested by the terminal. Then, the first AI NF network element may determine the execution task configured to realize the AI service based on the first request message, divide the execution task into the plurality of subtasks, deliver the plurality of subtasks to the plurality of second AI NF network elements for executing the task respectively, and receive execution results of the subtasks sent by the plurality of second AI NF network elements. It may be seen that the method for providing a service based on AI in the present disclosure is not a simple superposition on the existing network processes, but a complete set of general AI service providing process. Therefore, the method based on the present disclosure may accurately provide an AI service requested by a terminal to the terminal, which meets needs of personalized AI services. In addition, in the method of the present disclosure, by dividing the execution task corresponding to the AI service requested by the terminal into the plurality of subtasks, classified management of the AI service and a fine-grained division of AI functions may be realized, and a result of the AI service provided subsequently may be more accurate. Furthermore, in the method of the present disclosure, different second AI NF network elements execute subtasks in parallel, which may improve an execution efficiency. In addition, in the present disclosure, the first AI NF network element, the plurality of second AI NF network elements, and other network elements in the core network may form a unified technical framework for providing AI services, so as to avoid the problem of fragmentation of AI application scenarios.

FIG. 16 is a block diagram of a communication apparatus according to the embodiments of the present disclosure. As shown in FIG. 16, the apparatus may include:
a transceiver module, configured to receive a first request message sent by an AMF network element, in which the first request message indicates that there is an AI service requested by a terminal; and
a processing module, configured to determine an execution task configured to realize the AI service based on the first request message, and divide the execution task into a plurality of subtasks;
in which the transceiver module is further configured to deliver the plurality of subtasks to a plurality of second AI NF network elements for executing a task respectively, and receive execution results of the plurality of subtasks sent by the plurality of second AI NF network elements.

In summary, in the communication apparatus according to the embodiments of the present disclosure, the first AI NF network element used for decision-making may receive the first request message sent by the AMF network element, in which the first request message indicates that there is the AI service requested by the terminal. Then, the first AI NF network element may determine the execution task configured to realize the AI service based on the first request message, divide the execution task into the plurality of subtasks, deliver the plurality of subtasks to the plurality of second AI NF network elements for executing the task respectively, and receive execution results of the subtasks sent by the plurality of second AI NF network elements. It may be seen that the method for providing the service based on AI in the present disclosure is not a simple superposition on the existing network processes, but a complete set of general AI service providing process. Therefore, the method based on the present disclosure may accurately provide an AI service requested by a terminal to the terminal, which meets needs of personalized AI services. In addition, in the method of the present disclosure, by dividing the execution task corresponding to the AI service requested by the terminal into the plurality of subtasks, classified management of the AI service and a fine-grained division of AI functions may be realized, and a result of the AI service provided subsequently will be more accurate. Furthermore, in the method of the present disclosure, different second AI NF network elements execute subtasks in parallel, which may improve an execution efficiency. In addition, in the present disclosure, the first AI NF network element, the plurality of second AI NF network elements, and other network elements in the core network may form a unified technical framework for providing AI services, so as to avoid the problem of fragmentation of AI application scenarios.

Optionally, in one embodiment of the present disclosure, the apparatus is further configured to:
determine a final service execution result corresponding to the AI service based on the execution results of the plurality of subtasks; and
send the final service execution result corresponding to the AI service to the AMF network element.

Optionally, in one embodiment of the present disclosure, the first request message includes at least one of:
an AI service type corresponding to the AI service requested by the terminal;
an AI service ID corresponding to the AI service requested by the terminal; or
user information of the terminal.

Optionally, in one embodiment of the present disclosure, the processing module is further configured to:
determine an AI service type corresponding to the AI service;
determine an AI algorithm needed to realize the AI service; and

divide the execution task into the plurality of subtasks based on the AI service type and the AI algorithm.

Optionally, in one embodiment of the present disclosure, different second AI NF network elements are configured to execute subtasks of different task types:
in which the transceiver module is further configured to:
deliver the plurality of subtasks to corresponding second AI NF network elements based on task types corresponding to the plurality of subtasks.

Optionally, in one embodiment of the present disclosure, the apparatus is further configured to:
send user information of the terminal to the second AI NF network elements.

Optionally, in one embodiment of the present disclosure, the apparatus is further configured to:
send a first response message to the plurality of second AI NF network elements, in which the first response message indicates whether the first AI NF network element has successfully received the execution results of the plurality of subtasks.

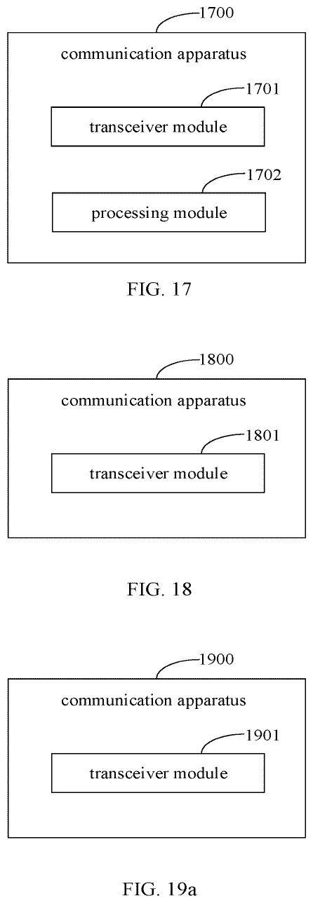

FIG. 17 is a block diagram of a communication apparatus according to the embodiments of the present disclosure. As shown in FIG. 17, the apparatus may include:
a transceiver module, configured to receive a subtask sent by a first AI NF network element used for decision-making; and
a processing module, configured to obtain an execution result of a subtask by executing the subtask;
in which the transceiver module is further configured to send the execution result of the subtask to the first AI NF network element.

In summary, in the communication apparatus according to the embodiments of the present disclosure, the first AI NF network element used for decision-making may receive the first request message sent by the AMF network element, in which the first request message indicates that there is the AI service requested by the terminal. Then, the first AI NF network element may determine the execution task configured to realize the AI service based on the first request message, divide the execution task into the plurality of subtasks, deliver the plurality of subtasks to the plurality of second AI NF network elements for executing the task respectively, and receive execution results of the subtasks sent by the plurality of second AI NF network elements. It may be seen that the method for providing the service based on AI in the present disclosure is not a simple superposition on the existing network processes, but a complete set of general AI service providing process. Therefore, the method based on the present disclosure may accurately provide an AI service requested by a terminal to the terminal, which meets needs of personalized AI services. In addition, in the method of the present disclosure, by dividing the execution task corresponding to the AI service requested by the terminal into the plurality of subtasks, classified management of the AI service and a fine-grained division of AI functions may be realized, and a result of the AI service provided subsequently will be more accurate. Furthermore, in the method of the present disclosure, different second AI NF network elements execute subtasks in parallel, which may improve an execution efficiency. In addition, in the present disclosure, the first AI NF network element, the plurality of second AI NF network elements, and other network elements in the core network may form a unified technical framework for providing AI services, so as to avoid the problem of fragmentation of AI application scenarios.

Optionally, in one embodiment of the present disclosure, the processing module is further configured to:
obtain data needed to execute the subtask from an NF network element based on the subtask; and
obtain a corresponding execution result of the subtask by executing the subtask based on the data.

Optionally, in one embodiment of the present disclosure, the NF network element includes at least one of:
a UDR network element; or
an UDSF network element.

Optionally, in one embodiment of the present disclosure, the second AI NF network element executes the subtask in parallel with another second AI NF network element.

Optionally, in one embodiment of the present disclosure, the apparatus is further configured to:
obtain user information of a terminal sent by the first AI NF network element, in which the terminal is a device requesting an AI service.

Optionally, in one embodiment of the present disclosure, the processing module is further configured to:
obtain the data needed to execute the subtask in data corresponding to the terminal from the NF network element based on the subtask.

Optionally, in one embodiment of the present disclosure, the second AI NF network element includes at least one AI model, in which the AI model is configured to output the execution result of the subtask based on the data.

Optionally, in one embodiment of the present disclosure, the apparatus is further configured to:
train the AI model based on local data.

Optionally, in one embodiment of the present disclosure, the apparatus is further configured to:
receive a first response message sent by the first AI NF network element, in which the first response message indicates whether the first AI NF network element has successfully received the execution result of the subtask.

FIG. 18 is a block diagram of a communication apparatus according to the embodiments of the present disclosure. As shown in FIG. 18, the apparatus may include:
a transceiver module, configured to receive a second request message sent by a terminal, in which the second request message indicates that there is an AI service requested by the terminal,
in which the transceiver module is further configured to send a first request message to a first AI NF network element, in which the first request message indicates that there is the AI service requested by the terminal;
the transceiver module is further configured to receive a final service execution result corresponding to the AI service sent by the first AI NF network element; and
the transceiver module is further configured to send the final service execution result corresponding to the AI service to the terminal.

In summary, in the communication apparatus according to the embodiments of the present disclosure, the first AI NF network element used for decision-making may receive the first request message sent by the AMF network element, in which the first request message indicates that there is the AI service requested by the terminal. Then, the first AI NF network element may determine the execution task configured to realize the AI service based on the first request message, divide the execution task into the plurality of subtasks, deliver the plurality of subtasks to the plurality of second AI NF network elements for executing the task respectively, and receive execution results of the subtasks sent by the plurality of second AI NF network elements. It may be seen that the method for providing the service based on AI in the present disclosure is not a simple superposition on the existing network processes, but a complete set of general AI service providing process. Therefore, the method based on the present disclosure may accurately provide an AI service requested by a terminal to the terminal, which meets needs of personalized AI services. In addition, in the method of the present disclosure, by dividing the execution task corresponding to the AI service requested by the terminal into the plurality of subtasks, classified management of the AI service and a fine-grained division of AI functions may be realized, and a result of the AI service provided subsequently will be more accurate. Furthermore, in the method of the present disclosure, different second AI NF network elements execute subtasks in parallel, which may improve an execution efficiency. In addition, in the present disclosure, the first AI NF network element, the plurality of second AI NF network elements, and other network elements in the core network may form a unified technical framework for providing AI services, so as to avoid the problem of fragmentation of AI application scenarios.

Optionally, in one embodiment of the present disclosure, both the first request message and the second request message include at least one of:
an AI service type corresponding to the AI service requested by the terminal;
an AI service ID corresponding to the AI service requested by the terminal; or
user information of the terminal.

Optionally, in one embodiment of the present disclosure, the apparatus is further configured to:
receive a second response message sent by the terminal, in which the second response message indicates whether the terminal has successfully received the final service execution result corresponding to the AI service.

Optionally, in one embodiment of the present disclosure, the apparatus is further configured to:
receive a feedback result sent by the terminal, in which the feedback result is configured to feed back a satisfaction degree with the final service execution result.

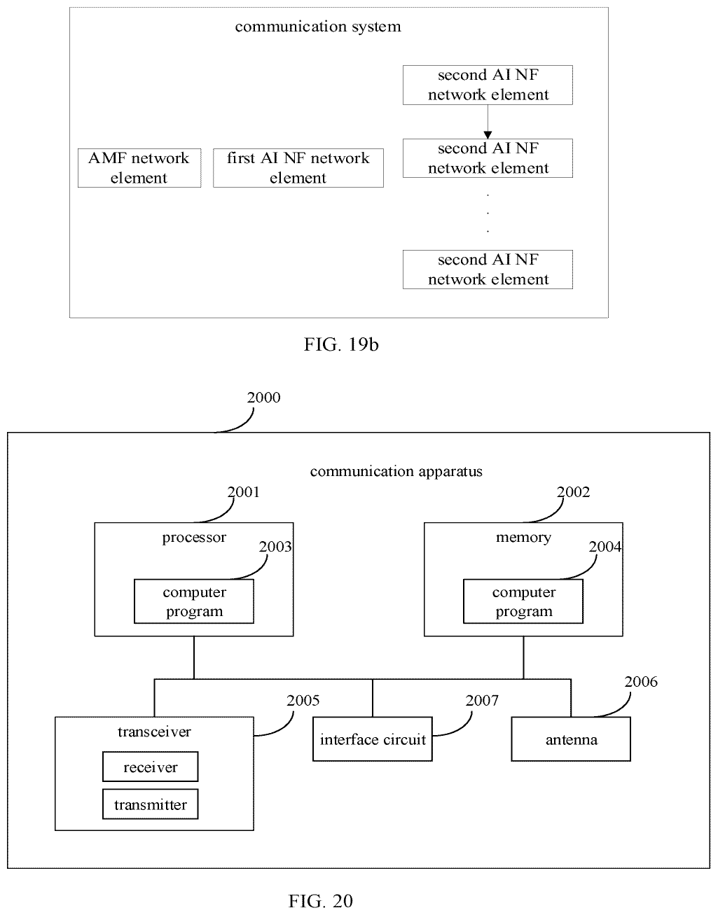

FIG. 19a is a block diagram of a communication apparatus according to the embodiments of the present disclosure. As shown in FIG. 19, the apparatus may include:
a transceiver module, configured to send a second request message to an AMF network element, in which the second request message indicates that there is an AI service requested by the terminal;
in which the transceiver module is configured to receive a final service execution result corresponding to the AI service sent by the AMF network element.

In summary, in the communication apparatus according to the embodiments of the present disclosure, the first AI NF network element used for decision-making may receive the first request message sent by the AMF network element, in which the first request message indicates that there is the AI service requested by the terminal. Then, the first AI NF network element may determine the execution task configured to realize the AI service based on the first request message, divide the execution task into the plurality of subtasks, deliver the plurality of subtasks to the plurality of second AI NF network elements for executing the task respectively, and receive execution results of the subtasks sent by the plurality of second AI NF network elements. It may be seen that the method for providing the service based on AI in the present disclosure is not a simple superposition on the existing network processes, but a complete set of general AI service providing process. Therefore, the method based on the present disclosure may accurately provide an AI service requested by a terminal to the terminal, which meets needs of personalized AI services. In addition, in the method of the present disclosure, by dividing the execution task corresponding to the AI service requested by the terminal into the plurality of subtasks, classified management of the AI service and a fine-grained division of AI functions may be realized, and a result of the AI service provided subsequently will be more accurate. Furthermore, in the method of the present disclosure, different second AI NF network elements execute subtasks in parallel, which may improve an execution efficiency. In addition, in the present disclosure, the first AI NF network element, the plurality of second AI NF network elements, and other network elements in the core network may form a unified technical framework for providing AI services, so as to avoid the problem of fragmentation of AI application scenarios.

Optionally, in one embodiment of the present disclosure, the second request message includes at least one of:
an AI service type corresponding to the AI service requested by the terminal;
an AI service ID corresponding to the AI service requested by the terminal; or
user information of the terminal.

Optionally, in one embodiment of the present disclosure, the apparatus is further configured to:
send a second response message to the AMF network element, in which the second response message indicates whether the terminal has successfully received the final service execution result corresponding to the AI service.

Optionally, in one embodiment of the present disclosure, the apparatus is further configured to:
send a feedback result to the AMF network element, in which the feedback result is configured to feed back a satisfaction degree with the final service execution result.

FIG. 19b is a block diagram of a communication system according to the embodiments of the present disclosure. As shown in FIG. 19b, the system may include:
a first network element (i.e. the AMF network element in the above embodiments), configured to receive a second request message sent by a terminal, in which the second request message indicates that there is an AI service requested by the terminal; and send a first request message, in which the first request message indicates that there is the AI service requested by the terminal;
a second network element (i.e. the first AI NF network element used for decision-making in the above embodiments), configured to receive the first request message, determine an execution task configured to realize the AI service based on the first request message, divide the execution task into a plurality of subtasks, and deliver the plurality of subtasks;
at least one third network element (i.e. the second AI NF network element used for executing a task in the above embodiments), configured to receive a subtask delivered, obtain an execution result of the subtask by executing the subtask, and send the execution result of the subtask,
in which the second network element is further configured to receive an execution result of each subtask, determine a final service execution result corresponding to the AI service based on the execution results of the plurality of subtasks, and send the final service execution result corresponding to the AI service to the AMF network element; and
the first network element is further configured to receive the final service execution result corresponding to the AI service, and send the final service execution result corresponding to the AI service to the terminal.

The first network element, the second network element, and the third network element may communicate with each other.

In summary; in the communication system according to the embodiments of the present disclosure, the first AI NF network element used for decision-making may receive the first request message sent by the AMF network element, in which the first request message indicates that there is the AI service requested by the terminal. Then, the first AI NF network element may determine the execution task configured to realize the AI service based on the first request message, divide the execution task into the plurality of subtasks, deliver the plurality of subtasks to the plurality of second AI NF network elements for executing the task respectively, and receive execution results of the subtasks sent by the plurality of second AI NF network elements. It may be seen that the method for providing the service based on AI in the present disclosure is not a simple superposition on the existing network processes, but a complete set of general AI service providing process. Therefore, the method based on the present disclosure may accurately provide an AI service requested by a terminal to the terminal, which meets needs of personalized AI services. In addition, in the method of the present disclosure, by dividing the execution task corresponding to the AI service requested by the terminal into the plurality of subtasks, classified management of the AI service and a fine-grained division of AI functions may be realized, and a result of the AI service provided subsequently will be more accurate. Furthermore, in the method of the present disclosure, different second AI NF network elements execute subtasks in parallel, which may improve an execution efficiency. In addition, in the present disclosure, the first AI NF network element, the plurality of second AI NF network elements, and other network elements in the core network may form a unified technical framework for providing AI services, so as to avoid the problem of fragmentation of AI application scenarios.

Optionally, the first request message includes at least one of:
an AI service type corresponding to the AI service requested by the terminal;
an AI service ID corresponding to the AI service requested by the terminal; or
user information of the terminal.

Optionally, the second network element is further configured to:
determine an AI service type corresponding to the AI service;
determine an AI algorithm needed to realize the AI service; and
divide the execution task into the plurality of subtasks based on the AI service type and the AI algorithm.

Optionally, different third network elements are configured to execute subtasks of different task types:
in which the second network element is further configured to:
deliver the plurality of subtasks to corresponding third network elements based on
task types corresponding to the plurality of subtasks.

Optionally, the second network element is further configured to:
send user information of the terminal to the third network elements.

Optionally, the second network element is further configured to:
send a first response message to the plurality of third network elements, in which
the first response message indicates whether the second network element has successfully received the execution results of the plurality of subtasks.

Optionally, the third network element is further configured to:
obtain data needed to execute the subtask from an NF network element based on the subtask; and
obtain a corresponding execution result of the subtask by executing the subtask based on the data.

Optionally, the NF network element includes at least one of:
a UDR network element; or
an UDSF network element.

Optionally, the third network element is further configured to: execute the subtask in parallel with another third network element.

Optionally, the third network element is further configured to:
obtain user information of a terminal sent by the second network element, in which the terminal is a device requesting an AI service.

Optionally, the third network element is further configured to:
obtain the data needed to execute the subtask in data corresponding to the terminal from the NF network element based on the subtask.

Optionally, the third network element includes at least one AI model, in which the AI model is configured to output the execution result of the subtask based on the data.

Optionally, the third network element is further configured to:
train the AI model based on local data.

Optionally, the third network element is further configured to:
receive a first response message sent by the second network element, in which the first response message indicates whether the second network element has successfully received the execution result of the subtask.

Optionally, the second request message includes at least one of:
an AI service type corresponding to the AI service requested by the terminal;
an AI service ID corresponding to the AI service requested by the terminal; or
user information of the terminal.

Optionally, the first network element is further configured to:
receive a second response message sent by the terminal, in which the second response message indicates whether the terminal has successfully received the final service execution result corresponding to the AI service.

Optionally, the first network element is further configured to:
receive a feedback result sent by the terminal, in which the feedback result is configured to feed back a satisfaction degree with the final service execution result.

Please refer to FIG. 20, which is a block diagram of a communication device 2000 according to the embodiments of the present disclosure. The communication device 2000 may be a network device, a terminal, or a chip, a chip system, a processor, etc. supporting the network device to implement the above methods, or a chip, a system on a chip, a chip system, a processor, etc. supporting the terminal to implement the above methods. The device may be used to implement the methods in the above method embodiments, which are described in the above method embodiments.

The communication device 2000 may include one or more processors 2001. The processor 2001 may be a general purpose processor or a special purpose processor. For example, it may be a baseband processor or a central processing unit. The baseband processor may be used to process communication protocols and communication data, and the central processing unit may be used to control communication devices (such as a base station, a baseband chip, a terminal, a terminal chip, a DU or a CU, etc.), to execute computer programs, and process computer program data.

Optionally, the communication device 2000 may also include one or more memories 2002 for storing a computer program 2004 and the processor 2001 executes the computer program 2004 to cause the communication device 2000 to implement the methods in the above method embodiments. Optionally, the memory 2002 may also store data. The communication device 2000 and the memory 2002 may be set separately or integrated together.

Optionally, the communication device 2000 may also include a transceiver 2005 and an antenna 2006. The transceiver 2005 may be called a transceiver unit, a transceiver machine, or a transceiver circuit, etc. to perform the transceiving function. The transceiver 2005 may include a receiver and a transmitter, in which the receiver may be called a receiving machine or a receiving circuit, etc. to perform the receiving function: the transmitter may be called a transmitting machine or a transmitting circuit, etc. to perform the transmitting function.

Optionally, the communication device 2000 may also include one or more interface circuits 2007. The interface circuit 2007 is configured to receive code instructions and transmit the code instructions to the processor 2001. When the processor 2001 executes the code instructions, the communication device 2000 is caused to implement the methods in the above method embodiments.

In one implementation, the processor 2001 may include a transceiver for performing the receiving function and the transmitting function. For example, the transceiver may be a transceiver circuit, or an interface, or an interface circuit. The transceiver circuit, the interface, or the interface circuit used to perform the receiving function and the transmitting function may be separate or integrated. The transceiver circuit, the interface, or the interface circuit may be used to read and write code/data, or the transceiver circuit, the interface, or the interface circuit may be used to transmit signals.

In one implementation, the processor 2001 may store a computer program 2003. When the computer program 2003 is running on the processor 2001, the communication device 2000 is caused to implement the method in the above method embodiments. The computer program 2003 may be solidified in the processor 2001, in which case the processor 2001 may be implemented by hardware.

In one implementation, the communication device 2000 includes a circuit that may implement the transmitting or receiving or communicating function in the above method embodiments. The processor and transceiver in the present embodiment may be implemented in an integrated circuit (IC), an analog IC, a radio frequency integrated circuit (RFIC), a mixed-signal IC, an application specific integrated circuit (ASIC), a printed circuit board (PCB), an electronic equipment, etc. The processor and transceiver may also be manufactured with various IC process technologies, such as a complementary metal oxide semiconductor (CMOS), nMetal-oxide-semiconductor (NMOS), a positive channel metal oxide semiconductor (PMOS), a bipolar junction transistor (BJT), a bipolar CMOS (BiCMOS), silicon germanium (SiGe), gallium arsenide (GaAs), etc.

The communication device in the above embodiments may be a network device or a terminal (such as the terminal in the method embodiments), but the scope of the communication device in the present embodiment is not limited to this, and the structure of the communication device may not be restricted by FIG. 20. The communication device may be an independent device or part of a larger device. For example, the communication device may be:
(1) an independent IC, or a chip, or a chip system or a subsystem;
(2) a collection including one or more IC, optionally, the IC collection may also include storage components for storing data and computer programs;
(3) an ASIC, such as a modem;
(4) modules embedded in other devices;
(5) a receiver, a terminal, an intelligent terminal, a cellular phone, a wireless device, a handheld phone, a mobile unit, a vehicle-mounted device, a network device, a cloud device, an artificial intelligence device, etc.;
(6) others.

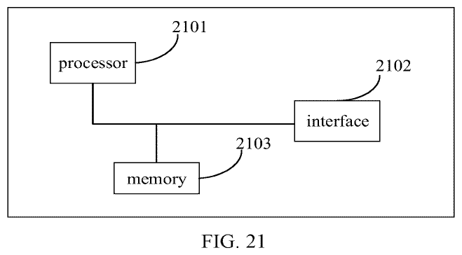

For the case where the communication device may be a chip or a chip system, please refer to the structural diagram of a chip in FIG. 21. The chip illustrated in FIG. 21 includes a processor 2101 and an interface 2102. There may be one or more processors 2101, and there may be a plurality of interfaces 2102.

Optionally, the chip also includes the memory 2103, which is used to store necessary computer programs and data.

Those skilled in the art may also understand that the various illustrative logical blocks and steps listed in the embodiments of the present disclosure may be implemented by electronic hardware, computer software, or their combination. Whether such a function is implemented in hardware or software depends on specific applications and design requirements of the overall system. Those skilled in the art may, for each specific application, use a variety of methods to achieve the above functions, but such implementation shall not be regarded as going beyond the scope of the protection of the embodiments of the present disclosure.

The embodiments of the present disclosure also provide a readable storage medium for storing instructions. When the instructions are executed by a computer, the function of any one of the above method embodiments is performed.

The embodiments of the present disclosure also provide a computer program product. When the computer program product is executed by a computer, the function of any one of the above method embodiments is performed.

In the above embodiments, the functions may be wholly or partially implemented by software, hardware, firmware, or any combination of them. When implemented by software, the functions may be implemented in whole or in part in the form of a computer program product.

The computer program product includes one or more computer programs. Procedures or functions according to embodiments of the present disclosure are wholly or partially generated when the computer program is loaded and executed on a computer. The computer may be a general purpose computer, a special purpose computer, a computer network, or other programmable device. The computer program may be stored in a computer-readable storage medium or transmitted from one computer-readable storage medium to another. For example, the computer program may be transmitted from one website, computer, server, or data center to another website, computer, server, or data center via wire (such as a coaxial cable, a fiber optic, a digital subscriber line (DSL)) or wireless (such as infrared, wireless, microwave). The computer-readable storage medium may be any available medium that may be accessed by a computer, or a data storage device such as a server that integrates one or more of the available media, and a data center. The available medium media be a magnetic medium (such as a floppy disk, a hard disk and a magnetic tape), an optical medium (such as a digital video disk (DVD)), or a semiconductor medium (such as a solid state disk (SSD)).

Those skilled in the art may understand that numbers like “first” and “second” in the present disclosure are only for the convenience of description, and are not used to limit the scope of the embodiments of the present disclosure, and also indicate a sequential order.

The term “at least one” in the present disclosure may also be described as one or more, and the more may be two, three, four, or more, which is not limited in the present disclosure. In the embodiment of the present disclosure, for a technical feature, the technical feature in the technical features are distinguished by terms “first”, “second”, “third”, “A”, “B”, “C” and “D”, etc., and the technical features described by the terms “first”, “second”, “third”, “A”, “B”, “C” and “D”, etc. are not in a sequential order or in an order of size.

Corresponding relationships indicated by tables in the present disclosure may be configured or pre-defined. Values of information in the tables are only examples, and may be configured as other values, which are not limited in the present embodiment. When the corresponding relationship between information and parameters is configured, it is not always necessary to configure all corresponding relationships indicated in tables. For example, in the tables of the present disclosure, corresponding relationships indicated by some rows may not be configured. For another example, appropriate transformations and adjustments, such as splitting and merging, may be made based on the above tables. Names of parameters shown in headers of the tables may be other names understandable by the communication apparatus, and values or representations of the parameters may be other values or representations understandable by the communication apparatus. When the above tables are implemented, other data structures may be used, for example, arrays, queues, containers, stacks, linear lists, pointers, linked lists, trees, graphs, structures, classes, heaps or hash tables may be used.

Pre-defined in the present embodiment may be understood as defined, pre-defined, stored, pre-stored, pre-negotiated, pre-configured, solidified or pre-fired.

Those skilled in the related art may realize that, in combination with units and algorithm steps of the examples described in embodiments of the present disclosure, may be implemented by an electronic hardware or a combination of an electronic hardware and a computer software. Whether the functions are executed by the hardware or the software depends on a specific application and a design constraint of the technical solutions. Those skilled in the art may adopt different methods for each specific application to implement the described functions, but such implementation should not be considered as going beyond the scope of the present disclosure.

Those skilled in the art may clearly understand that, a specific working process of a system, an apparatus and a unit described above may refer to a corresponding process in the above method embodiments, which will not be repeated here.

The above are only implementations of the present embodiment. However, the protection scope of the present embodiment is not limited here. Changes and substitutions that may be easily considered by those skilled in the art shall be contained within the protection scope of the present disclosure. Therefore, the protection scope of the present embodiment shall be subject to the protection scope of claims.

1. A method for providing a service based on artificial intelligence (AI), executed by a first AI network function (NF) network element used for decision-making, comprising:
receiving a first request message sent by an access and mobility management function (AMF) network element, wherein the first request message indicates that there is an AI service requested by a terminal;
determining an execution task configured to realize the AI service based on the first request message, and dividing the execution task into a plurality of subtasks; and
delivering the plurality of subtasks to a plurality of second AI NF network elements for executing a task respectively, and receiving execution results of the plurality of subtasks sent by the plurality of second AI NF network elements.

2. The method of claim 1, further comprising:
determining a final service execution result corresponding to the AI service based on the execution results of the plurality of subtasks; and
sending the final service execution result corresponding to the AI service to the AMF network element.

3. The method of claim 1, wherein the first request message comprises at least one of:
an AI service type corresponding to the AI service requested by the terminal;
an AI service identifier (ID) corresponding to the AI service requested by the terminal; or
user information of the terminal.

4. The method of claim 1, wherein dividing the execution task into the plurality of subtasks comprises:
determining an AI service type corresponding to the AI service;
determining an AI algorithm needed to realize the AI service; and
dividing the execution task into the plurality of subtasks based on the AI service type and the AI algorithm.

5. The method of claim 1, wherein different second AI NF network elements are configured to execute subtasks of different task types;
wherein delivering the plurality of subtasks to the plurality of second AI NF network elements for executing the task respectively comprises:
delivering the plurality of subtasks to corresponding second AI NF network elements based on task types corresponding to the plurality of subtasks.

6. The method of claim 1, further comprising:
sending user information of the terminal to the second AI NF network elements.

7. The method of claim 1, further comprising:
sending a first response message to the plurality of second AI NF network elements, wherein the first response message indicates whether the first AI NF network element has successfully received the execution results of the plurality of subtasks.

8. (canceled)

9. The method of claim 1, wherein the execution result of each subtask is determined by:
obtaining data needed to execute the subtask from an NF network element based on the subtask; and
obtaining a corresponding execution result of the subtask by executing the subtask based on the data.

10. The method of claim 9, wherein the NF network element comprises at least one of:
a user data repository (UDR) network element; or
an unstructured data storage network function (UDSF) network element.

11-12. (canceled)

13. The method of claim 9, wherein
the data needed to execute the subtask in data corresponding to the terminal is obtained from the NF network element based on the subtask.

14. The method of claim 9, wherein the second AI NF network element comprises at least one AI model, wherein the AI model is configured to output the execution result of the subtask based on the data, and the AI model is trained based on local data of the second AI NF network element.

15-16. (canceled)

17. A method for providing a service based on artificial intelligence (AI), executed by a mobility management function (AMF) network element, comprising:
receiving a second request message sent by a terminal, wherein the second request message indicates that there is an AI service requested by the terminal;
sending a first request message to a first AI network function (NF) network element, wherein the first request message indicates that there is the AI service requested by the terminal;
receiving a final service execution result corresponding to the AI service sent by the first AI NF network element; and
sending the final service execution result corresponding to the AI service to the terminal.

18. The method of claim 17, wherein both the first request message and the second request message comprise at least one of:
an AI service type corresponding to the AI service requested by the terminal;
an AI service identifier (ID) corresponding to the AI service requested by the terminal; or
user information of the terminal.

19. The method of claim 17, further comprising at least one of:
receiving a second response message sent by the terminal, wherein the second response message indicates whether the terminal has successfully received the final service execution result corresponding to the AI service; or
receiving a feedback result sent by the terminal, wherein the feedback result is configured to feed back a satisfaction degree with the final service execution result.

20. (canceled)

21. A method for providing a service based on artificial intelligence (AI), executed by a terminal, comprising:
sending a second request message to an access and mobility management function (AMF) network element, wherein the second request message indicates that there is an AI service requested by the terminal; and
receiving a final service execution result corresponding to the AI service sent by the AMF network element.

22. The method of claim 21, wherein the second request message comprises at least one of:
an AI service type corresponding to the AI service requested by the terminal;
an AI service identifier (ID) corresponding to the AI service requested by the terminal; or
user information of the terminal.

23. The method of claim 21, further comprising at least one of:
sending a second response message to the AMF network element, wherein the second response message indicates whether the terminal has successfully received the final service execution result corresponding to the AI service; or
sending a feedback result to the AMF network element, wherein the feedback result is configured to feed back a satisfaction degree with the final service execution result.

24-28. (canceled)

29. A first AI NF network element,
comprising a processor and a memory for storing a computer program, wherein when the computer program stored in the memory is executed by the processor, the processor is caused to implement the method of claim 1.

30-32. (canceled)

33. A second AI NF network element, comprising a processor and a memory for storing a computer program, wherein when the computer program stored in the memory is executed by the processor, the processor is caused to implement the method of claim 17.

34. A terminal, comprising a processor and a memory for storing a computer program, wherein when the computer program stored in the memory is executed by the processor, the processor is caused to implement the method of claim 21.
